(19) United States
(12) Patent Application Publication
(10) Pub. No.: US 2009/0058158 A1
(43) Pub. Date: Mar. 5, 2009

(54) 2 IN 1 OPERATING LEVER

(76) Inventor: Zdzislaw Sobieski, Allershausen-Leonhardsbuch (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/867,845

(22) Filed: Oct. 5, 2007

(30) Foreign Application Priority Data
Oct. 6, 2006 (DE) DE 102006047398.1

(51) Int. Cl. B60N 2/02; B60N 2/16; B60N 2/20

(52) U.S. Cl. 297/338; 297/463.1; 297/362; 297/358; 297/344.15

(57) ABSTRACT

An adjustment assembly including a 2 in 1 activating lever that has two operating positions, a forward position and a rearward position. The 2 in 1 activating lever is operatingly coupled to a bracket including a first and second cam that are operatingly coupled to an inner and outer rotating shaft. In the forward position, the movement of the 2 in 1 activating lever upward or downward causes the first cam and inner rotating shaft to rotate clockwise or counterclockwise. In the rearward position, the movement of the 2 in 1 activating lever upward or downward causes the second cam and outer rotating shaft to rotate clockwise or counterclockwise. The adjustment assembly may be utilized on an automotive seat assembly to control both the seat height and seat inclination angle.

### TECHNICAL FIELD

The present invention relates generally to adjustable seats and more specifically to 2 in 1 operating lever for adjustable seats.

### BACKGROUND OF THE INVENTION

Seats including mechanisms for providing adjustment of the height, inclination, and forward and rearward positioning of the seat are well known. Some of these seat adjustment mechanisms include hand-operated levers and associated mechanisms and components employed for positioning and moving the seat longitudinally. Other seat assemblies include an actuating handle and associated mechanism and components which are used to actuate rotational movement of a seat assembly about a vertical axis and a separate actuating handle and associated mechanism to actuate longitudinal movement of the seat both forward and backwards with respect to the vehicle.

The use of multiple levers that each control a particular adjustment of the seat (height, inclination, and/or forward and rearward positioning) has inherent disadvantages associated with both their design and function. Each individual lever must be sized and positioned along the seat assembly in such a way that allows user to easily control their actuation. However, the positioning of multiple levers along the seat assembly in such a way that is both space efficient and user friendly is challenging.

In addition, the use of multiple levers adds to costs in terms of manufacturing and assembly, in that each individual lever must be formed and placed in their proper position that allows them to accomplish their desired function. In addition to increasing the complexity of the design, the likelihood of failure of one or more parts associated with each of the multiple layers adds further costs associated with repair or replacement.

It is therefore highly desirable to minimize the use of multiple levers used to control seat adjustment. Such a reduction in the number of levers may also be desirable for use in any other type of similar mechanism requiring conventionally multiple levers for control.

### SUMMARY OF THE INVENTION

It is therefore an object of the present invention to provide a new adjustment assembly that reduces the number of levers typically used to control mechanism. The adjustment assembly is ideally suited for use in an adjustable seat assembly, in that it eliminates some of the inherent problems associated with prior art seat assemblies using multiple levers to accomplish individual seat adjustments.

The adjustment assembly includes an operating lever that replaces multiple levers used in prior systems. This operating lever, known hereinafter as a 2 in 1 activating lever, has two operating positions, a forward position and a rearward position. The 2 in 1 activating lever is operatingly coupled to a bracket including a first and second cam. The first cam is operatingly coupled to an inner or outer rotating shaft when the 2 in 1 activating lever is in the forward position, and uncoupled from the same rotating shaft when the 2 in 1 activating lever is in the rearward position. Conversely, the second cam is operatingly coupled to other of the two rotating shafts when the 2 in 1 activating lever is the forward position and operatingly uncoupled from the other of the two rotating shafts when the 2 in 1 activating lever is in the rearward position.

In the forward position, the movement of the 2 in 1 activating lever upward or downward causes the first cam to rotate clockwise or counterclockwise. The rotation of the first cam in turn causes the respective rotating shaft to rotate as well.

In the rearward position, the movement of the 2 in 1 activating lever upward or downward causes the second cam to rotate clockwise or counterclockwise. The rotation of the second cam in turn causes an outer rotating shaft to rotate in response.

In an automotive seat assembly wherein the inner rotating shaft is coupled either a seat height adjustment assembly or a seat inclination adjustment assembly and the outer rotating shaft is coupled to the other of the seat height adjustment assembly and a seat inclination adjustment assembly, the 2 in 1 operating lever can be used to control both the seat height and seat inclination angle by simply sliding the 2 in 1 activating lever between a forward and rearward position and pulling up on the lever to then engage the coupled adjustment assembly to allow a user to raise or lower the seat, or incline the seat, in response. By pushing back down on the 2 in 1 lever, the assemblies are locked, therein locking the relative height and inclination of the seat assembly.

The present invention thus addresses some of the deficiencies in the prior art that utilize multiple seat levers to control adjustment of mechanisms, including seat assemblies. The present invention is user-friendly and inexpensive to manufacture and assemble.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of an adjustable automotive seat assembly in accordance with a preferred embodiment of the present invention including a seat adjustment assembly having adjustment assembly in a forward position;

FIG. 2 is an illustration of an adjustable automotive seat assembly of FIG. 1 in which the adjustment assembly is a rearward position;

FIG. 3 is a perspective view of the adjustment assembly, seat height adjustment assembly, and seat inclination assembly of FIGS. 1 and 2;

FIG. 4A is a perspective view of an automotive seat assembly of FIG. 1 with the seat height in a lowered position;

FIG. 4B is a close-up view of a portion of FIG. 4A;

FIG. 5 is a perspective view of an automotive seat assembly of FIG. 1 with the seat height in a raised position;

FIG. 6A is a perspective view of an automotive seat assembly of FIG. 2 with the backrest in a rearward angled position;

FIG. 6B is a close-up view of a portion of FIG. 4A; and

FIG. 7 is a perspective view of an automotive seat assembly of FIG. 2 with the backrest in a forward angled position.

### DESCRIPTION OF PREFERRED EMBODIMENTS

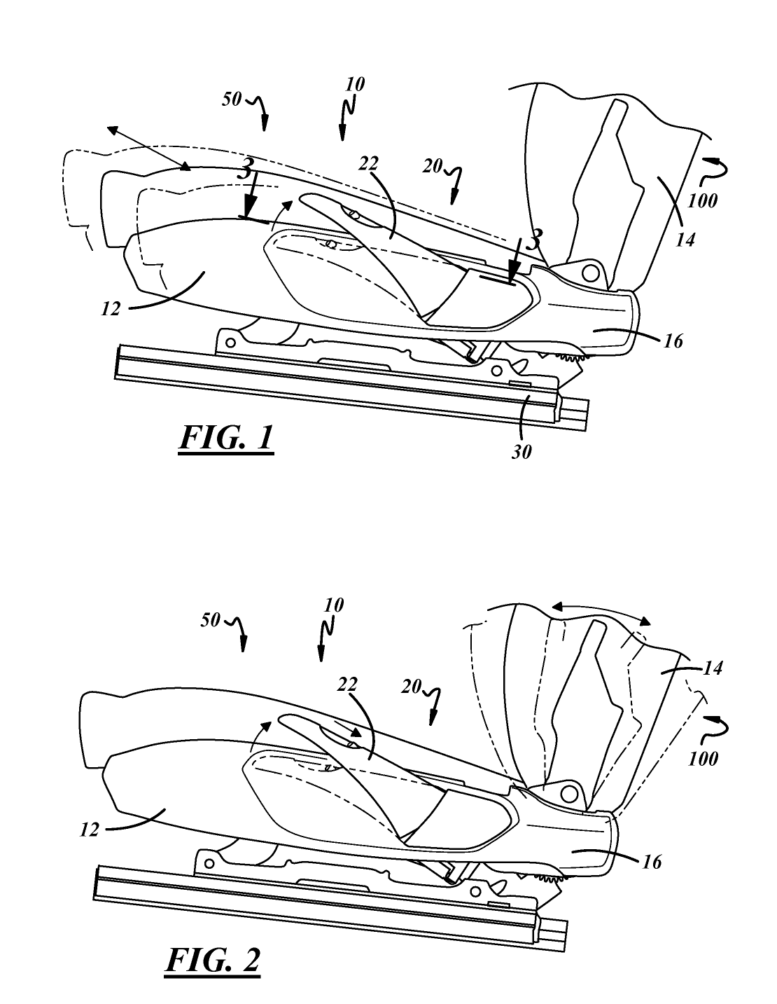

Referring now to FIGS. 1-7, which is an illustration of an adjustment assembly 20 including a 2 in 1 operating lever 22 used in one potential and preferred application, here an automotive seat assembly 10. The automotive seat assembly 10 illustrated is intended to encompass a wide variety of seating configurations for both front and rear automotive seats. The seat assembly 10 includes a seat rest 12 and a seat back 14. A headrest (not shown) may also be used in conjunction with the seat back 14 for further passenger comfort. The adjustment assembly 20 has a 2 -in 1 activating lever 22 coupled to side portion 16 of the seat rest 12. The seat assembly 10 also includes a pair of rails 30 for securing the seat to the floor of the vehicle. The rails 30 also allow for the sliding adjustment of the seat assembly 10 forward and rearward relative to the steering wheel (not shown) and, as described further below, function, in conjunction with components of the seat height adjustment assembly 50, to allow the seat rest 12 to be raised or lowered.

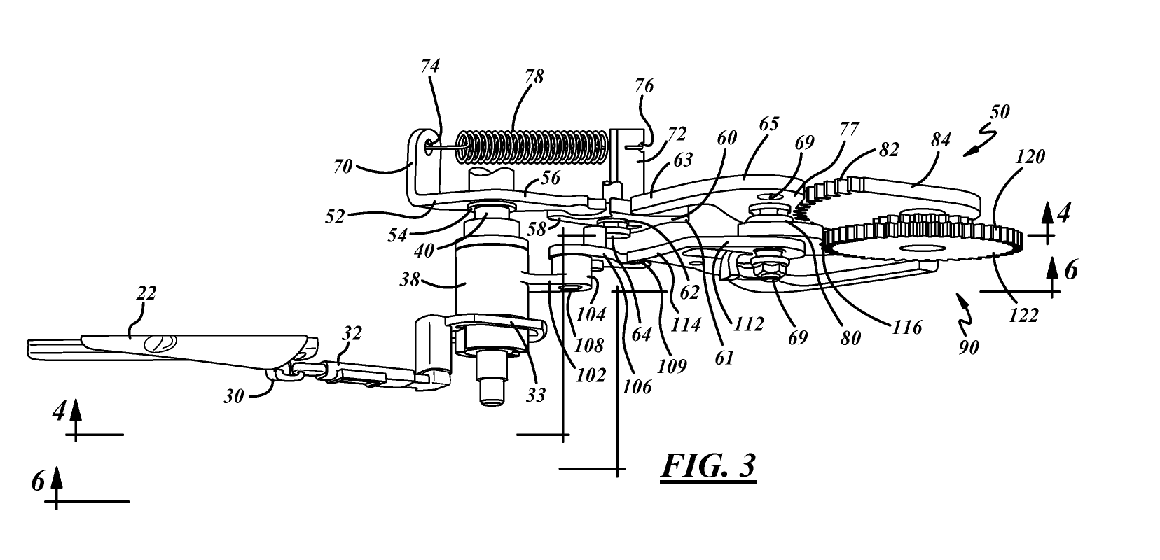

As best shown FIGS. 3-7, the adjustment assembly 20 having the 2 in 1 activating lever 22 is illustrated in which the lever 22 is fixed by a spring 24 in either a forward notch 26 or rearward notch 28 of a base assembly 29 which is coupled to the side portion 16. The adjustment assembly 20 is coupled to a seat height adjustment assembly 50 and a seat inclination adjustment assembly 100 that allows the seat rest 12 to be moved upward or downward, or the seat back 14 to be inclined more forwardly or rearwardly, relative to the seat rest 12, depending upon the positioning of the activating lever 22. The seat height adjustment assembly 50 and seat inclination adjustment assembly 100 are conventional in design, and thus are described herein to merely aid in describing the function of the adjustment assembly 20. The only requirements of the assemblies 50, 100 are that they must be operatingly coupled to the shaft member (shown as 38 in FIGS. 3-7) such that their respective movements to control the height and inclination angle of the seat are controlled by the user by movement of the adjustment assembly 20 as described in the following paragraphs.

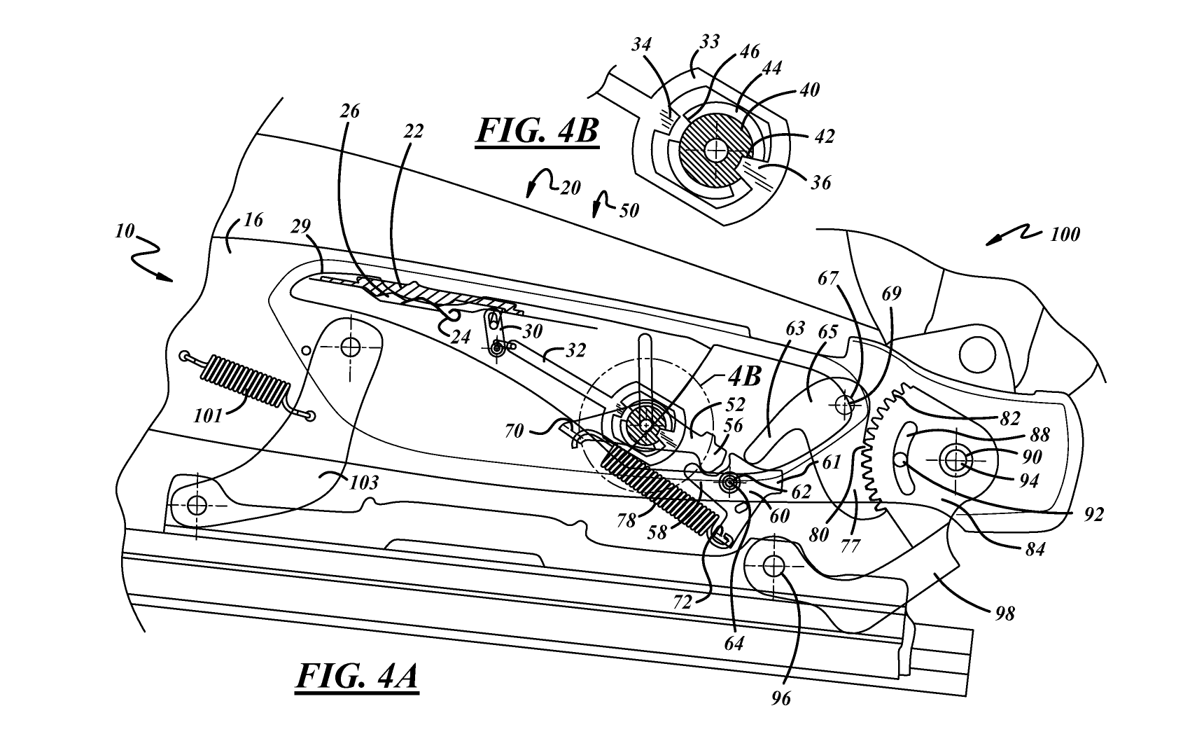

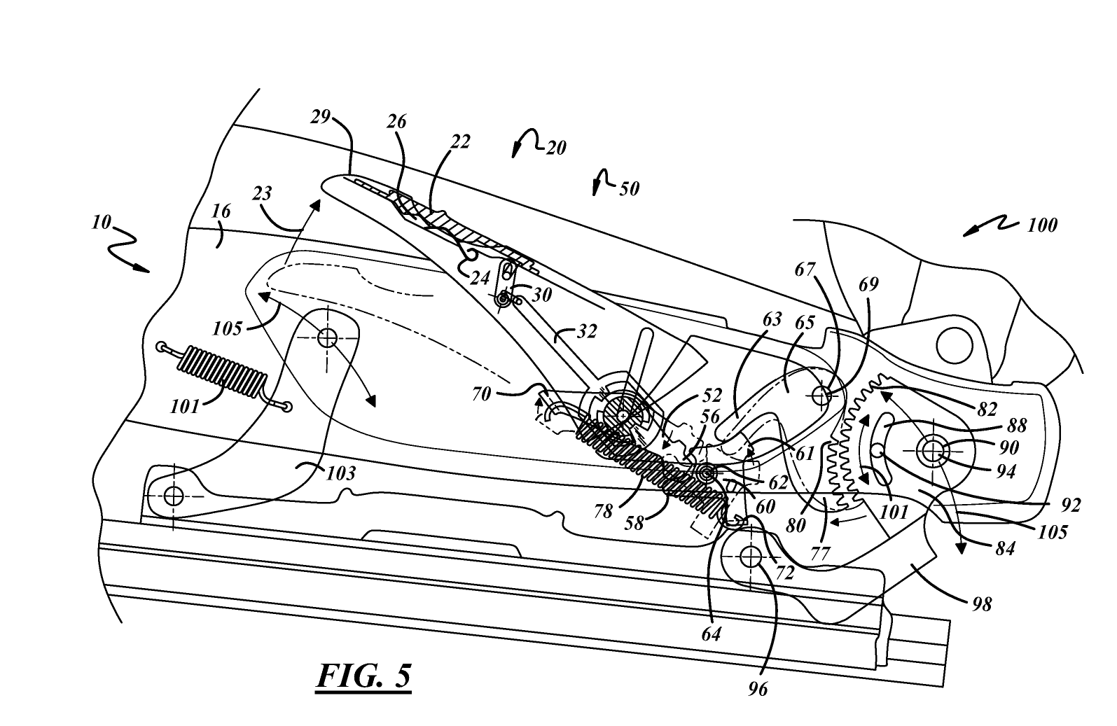

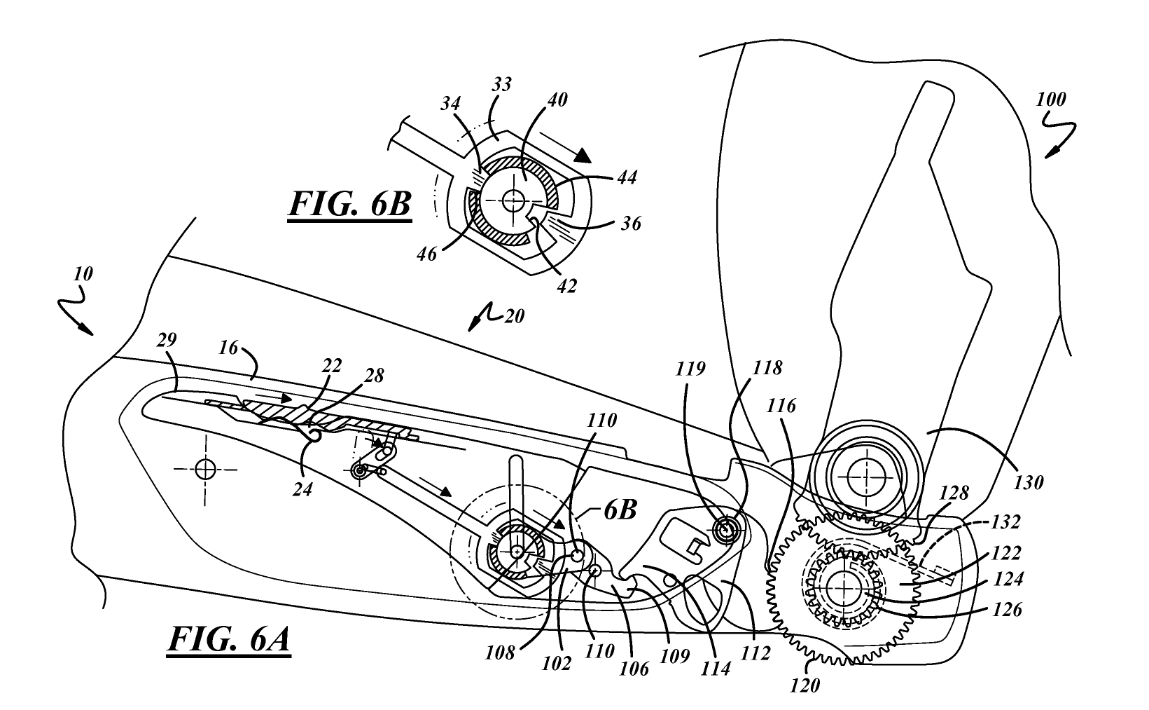

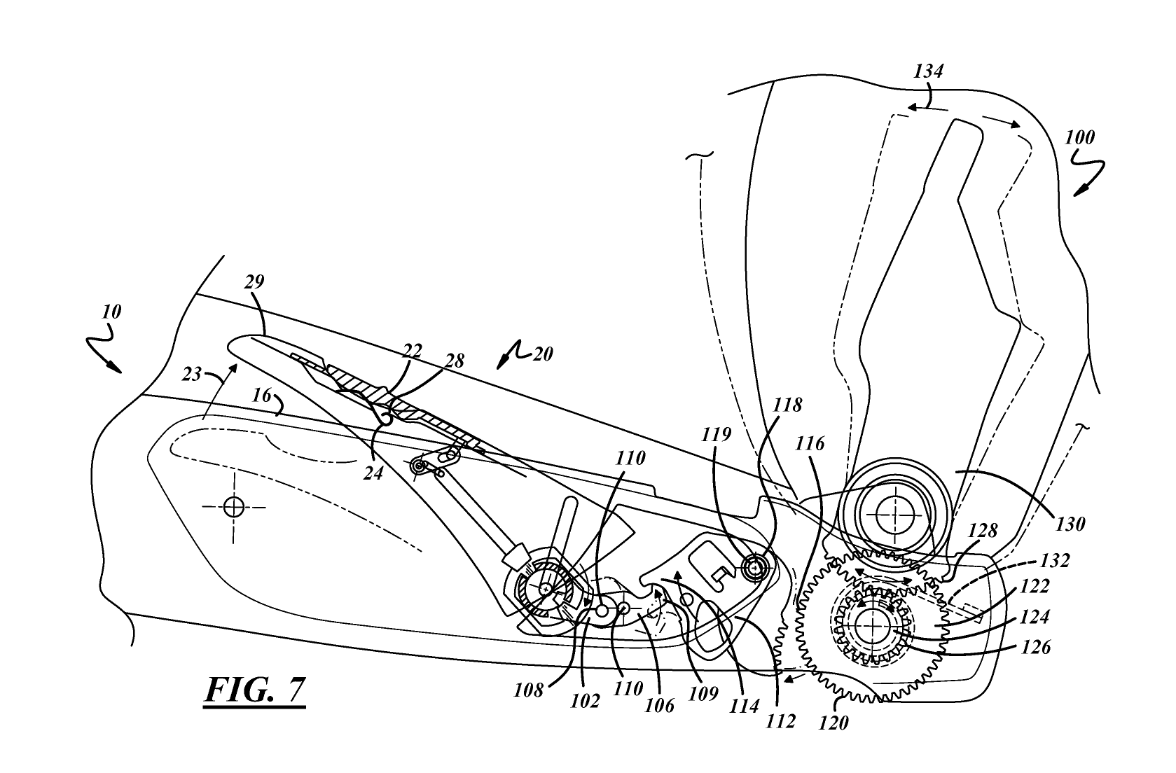

When the lever 22 is coupled within the forward notch 26, the adjustment assembly 20 actuates the seat adjustment assembly 50 such that it is capable of adjusting the seat height from a lowered position, as shown in FIG. 4A, to a raised position, as shown in FIG. 5. When the a 2 in 1 activating lever 22 is coupled within the rearward notch 28, the adjustment assembly 20 actuates the seat inclination assembly 100 such that it is capable of adjusting the inclination of the seat back 14 relative to the seat rest 12 from a rearwardly inclined position, as shown in FIG. 6A, to a more forwardly inclined position, as shown in FIG. 7. The adjustment assembly 20, in conjunction with the seat adjustment assembly 50, is described in more detail below with respect to FIGS. 1, 4A, 4B and 5, while the adjustment assembly 20, in conjunction with the seat inclination assembly 100, is discussed further below with respect to FIGS. 2, 6A, 6B and 7.

The adjustment assembly 20 includes the activating lever 22 that is coupled to a second lever 30, which in turn is coupled to a slide 32. The slide 32 is coupled to a bracket 33 including a front cam 34 and a back cam 36. As best shown in FIGS. 4B and 6B, the bracket 33 is coupled around a shaft member 38 having an inner rotating shaft 40 having a notched region 42 and an outer rotating shaft 44 having a notched region 46. The inner rotating shaft 40 is coupled to a seat height adjustment assembly 50, while the outer rotating shaft 44 is coupled to a seatback inclination assembly 100.

The seat height adjustment assembly 50 consists of a first plate 52 that includes a first opening 54 for coupling to the inner rotating shaft 40 and an arm portion 56 that is closely coupled with a corresponding slotted arm 58 of a second plate 60. The first plate 52 rotates or pivots about the inner rotating shaft 40.

The second plate 60 also includes an opening 62 through which a bolt 64 is introduced to secure the second plate 60 to the side portion 16. The bolt 64 also functions as a pivot point for the second plate 60. The second plate 60 includes an arm portion 61 that is closely coupled with an arm portion 63 of a third plate 65.

The first plate 52 and second plate 60 also each have a perpendicular flange portion 70, 72 including a respective opening 74, 76. A spring 78 is coupled to the first plate 52 through an opening 74 and within a notched area 76 of a second plate 60. The spring 78 aids in maintaining the positioning of the first plate 52 and second plate 60 relative to one another when the activating lever 22 is positioned within the rearward notch 28, therein maintaining the relative location of the notched region 46 adjacent to the front cam 34 such that the rear cam 36 may be slidingly positioned in the notched region 42 if the lever 22 be moved from the rearward notch 28 to the forward notch 26.

The third plate 65 includes also includes an opening 67 through which a bolt 69 is introduced to secure the third plate 65 to the side portion 16. The bolt 69 also functions as a pivot point for the third plate 65. The third plate 65 also includes an arm portion 77 and a plurality of gear teeth 80 that are couple to a plurality of corresponding gear teeth 82 on a fourth plate 84.

The fourth plate 84 includes an elongated opening 88 and a larger opening 90. A pin 92 from the side portion 16 extends through the opening 88, while a bolt 94 secures the fourth plate 84 to the side portion 16 through the larger opening 90. The bolt 94 serves as the pivot point for the fourth plate 84.

The fourth plate 84 also includes a flange region 98 having a circular opening 96 that is coupled to the rail 30. A fifth plate 103 coupled to the rail 30 is movingly coupled to the fourth plate 84, and both the fourth plate 84 and fifth plate 103 are biased upward (as shown in FIG. 4A) by spring 101. The seat rest 12 may be moved by moving the fourth plate 84 and fifth plate 103 downward, as shown by arrow 105, against the bias of spring 101.

Referring now to FIGS. 4A, 4B and 5, the adjustment of the seat height is accomplished by first coupling lever 22 within the forward notch 26, which causes the second lever 30 and slide portion 32 to move such that the bracket 33 is moved such that the back cam 36 is coupled within notched region 42, which allows movement of the inner rotating shaft 40.

Next, the lever 22 is pulled upwardly (shown by arrow 23 in FIG. 5). The movement of the lever 22 upwards causes the second lever 30 and slide portion 32 to move in response, which causes the bracket 33 and back cam 36 to rotate in a first direction, shown as clockwise in FIG. 5. The rotation of the back cam in turn causes the inner rotating shaft 40 to rotate in a clockwise direction. The rotation of the inner rotating shaft 40 in a clockwise direction moves the arm portion 56 of the first plate 52 into contact within the slotted arm 58 of the second plate 60, therein causing the second plate 60 to rotate in the opposite direction (here counterclockwise) around the bolt 64 in response against the spring 78. The rotation of the second plate 60 causes the arm portion 61 to contact the corresponding arm portion 63 of the third plate 65, causing the third plate 65 to rotate in the opposite direction from the second plate 60 (here clockwise).

The rotation of the third plate 65 clockwise causes the gear teeth 80 to disengage the corresponding gear teeth 82 on the fourth plate 84, which allows the fourth plate 84 to freely move in the direction of arrow 101, depending upon the amount of force a person displaces the seat rest 12 downward against the biasing spring 101. When the user achieves the desired seat rest height, the user simply moves the lever 22 downward, therein causing the bracket 33 and back cam 36 to rotate in a second direction (counterclockwise as shown in FIG. 5), which remotely causes the gear teeth 80 to engage the corresponding gear teeth 82 on the fourth plate 84, therein locking the gear teeth 80, 82 and preventing movement of the fourth plate 64 and fifth plate 103. This locks the seat rest height to a desired height relative to the floor of the vehicle.

Referring now to FIGS. 6A, 6B and 7, the seatback inclination assembly 100 includes the afore-mentioned outer rotating shaft 44 that includes a flange portion 102 coupled to a cylinder portion 104.

A plate 106 having a seating pin 108 is coupled within the inner opening 110 of the hollow cylinder portion 104 and rotates around pivot point 110, which is coupled to side portion 16, as the flange portion 102 and hollow cylinder 104 rotate. The plate 106 includes an arm region 109. The arm region 109 is closely coupled with a corresponding flanged portion 114 of a second plate 112.

The second plate 112 also includes a plurality of gear teeth 116 and an opening 118. A bolt 119 for coupling the second plate 112 to the side portion 16 is coupled through the opening 118 and acts as a pivot point for the second plate 112. The gear teeth 116 are closely coupled with corresponding gear teeth 120 on a sprocket 122. The sprocket 122 is coupled to a second sprocket 124 having a plurality of gear teeth 126, which is coupled to a plurality of corresponding gear teeth 128 on a backrest adjustment flange 130, which extends into the seat back 14 and is coupled to a spring 132.

To actuate the seatback inclination assembly 112, the 2 in 1 activating lever 22 is moved by the user into the rearward notch 28, which causes the lever 30 and slide 32 to move such that the bracket 33 is positioned wherein the back cam 36 is uncoupled from the notched region 42 and wherein the front cam 34 is coupled within the notched region 46 of the outer rotating shaft 44.

Next, the user pulls the lever 22 upward, as shown by arrow 23 in FIG. 7, which causes the lever 30 and slide 32 to move such that the bracket 33 rotates in a first direction, shown in FIG. 7 as clockwise. The rotation of the bracket 33 causes the forward cam 36 to rotate, which rotates the outer rotating shaft 44 in the first direction in response.

The rotation of the outer rotating shaft 44 in turn causes the flange portion 102 and cylinder portion 104 to rotate clockwise in response. This in turn causes the plate 106 to rotate in the first direction, shown as counterclockwise in FIG. 7, which causes the arm region 109 to contact the corresponding flange portion 114 of the second plate 112 and rotate the second plate 112 in the opposite direction, shown in FIG. 7 as clockwise.

The rotation of the second plate 112 causes the gear teeth 116 to disengage from the gear teeth 120 of sprocket 122, thus allowing the sprocket 122 to freely rotate. This allows the backrest adjustment flange 132 to bias forward away from the spring, as shown by arrow 134. The user may resist the force of the spring 132 to move the backrest adjustment flange 130 rearward against the force of the spring 132. As this occurs the different gear teeth 126 of sprocket 124 are intermingled with new corresponding gear teeth 128 of the backrest adjustment flange 130. When the user finds the desired seatback inclination angle, the user simply moves the lever 22 downward, which remotely causes the gear teeth 120 to engage the corresponding gear teeth 120 of the sprocket 122, therein locking the backrest adjustment flange 130 and seat back 14 at the desired inclination angle.

As one of ordinary skill appreciates, the rotational direction of the components of the adjustment assembly 20, seat height adjustment assembly 50 and seat inclination adjustment assembly 10 in a clockwise or counterclockwise direction are only relevant when describing the relationship of movements between associated components, and are thus not limited to the rotational arrangement described herein.

As one of ordinary skill would also appreciate, in an alternative preferred embodiment (not shown), the seat adjustment assembly 50 and seat inclination assembly 100 could be coupled to the adjustment assembly 20 in the opposite manner to that described in FIGS. 1-7. In this arrangement, the seat adjustment assembly 50 is coupled to the outer rotating shaft 44, as opposed to the inner rotating shaft 40, while the seat inclination assembly 100 is coupled to the inner rotating shaft 40, not the outer rotating shaft 44. Thus, when the 2 in 1 activating lever 22 is contained within the forward notch 26 and the lever 22 moved upward, the seat inclination assembly 100 is acted upon to change the relative inclination angle of the seat back 14 relative to the seat rest 12. Also, when the 2 in 1 activating lever 22 is contained within the rearward notch 28 and the lever 22 moved upward, the seat height adjustment assembly 50 is acted upon to raise or lower the seat rest 12 relative to the floor.

The present invention thus addresses some of the deficiencies in the prior art that utilize multiple seat levers to control adjustment of the seat. The present invention is user-friendly and inexpensive to manufacture and assemble.

In addition, the 2 in 1 lever, and its associated components, may be utilized in other type of applications requiring multiple levers to control associated functions.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An adjustment assembly comprising:
a base assembly having a forward notch and a rearward notch;
a 2 in 1 activating lever having a spring coupled to said base assembly and moveable between a forward position and a rearward position and independently moveable between a downward position and upward position, said forward position characterized wherein said spring is contained within said forward notch and said rearward position characterized wherein said spring is contained within said rearward notch;
a shaft member having an inner rotating shaft and an outer rotating shaft; and
a bracket including a front cam and a rear cam remotely coupled to said 2 in 1 activating lever and coupled to said shaft member;
wherein said front cam is coupled to and rotatable with said outer rotating shaft when said 2 in 1 activating lever is in said rearward position and wherein said rear cam is coupled to and rotatable with said inner rotating shaft when said 2 in 1 activating lever is in said forward position.

2. The adjustment assembly of claim 1 further characterized wherein said front cam and said outer rotating shaft rotate in a first direction when said 2 in 1 activating lever is in said rearward position and said upward position, wherein said first direction is selected from the group consisting of a clockwise direction and a counterclockwise direction.

3. The adjustment assembly of claim 1 further characterized wherein said rear cam and said inner rotating shaft rotate in a first direction when said 2 in 1 activating lever is in said forward position and said upward position, wherein said first direction is selected from the group consisting of a clockwise direction and a counterclockwise direction.

4. The adjustment assembly of claim 1 further characterized wherein said front cam and said outer rotating shaft rotate in a first direction when said 2 in 1 activating lever is in said rearward position and said upward position; and
wherein said rear cam and said inner rotating shaft rotate in a first direction when said 2 in 1 activating lever is in said forward position and said upward position, wherein said first direction is selected from the group consisting of a clockwise direction and a counterclockwise direction.

5. The adjustment assembly of claim 1 further comprising:
a first lever coupled to said 2 in 1 activating lever; and
a slide coupled between said 2 in 1 activating lever and said bracket.

6. An adjustable automotive seat assembly including the adjustment assembly of claim 1.

7. An adjustable automotive seat assembly for an automobile comprising:
(a) an automotive seat assembly including a seat rest and a seat back coupled to the floor of an automobile;
(b) an adjustment assembly coupled to said automotive seat assembly comprising:
a base assembly having a forward notch and a rearward notch;
a 2 in 1 activating lever having a spring coupled to said base assembly and moveable between a forward position and a rearward position and independently moveable between a downward position and upward position, said forward position characterized wherein said spring is contained within said forward notch and said rearward position characterized wherein said spring is contained within said rearward notch;
a shaft member having an inner rotating shaft and an outer rotating shaft; and
a bracket including a front cam and a rear cam remotely coupled to said 2 in 1 activating lever and coupled to said shaft member; wherein said front cam is coupled to and rotatable with said outer rotating shaft when said 2 in 1 activating lever is in said rearward position and wherein said rear cam is coupled to and rotatable with said inner rotating shaft when said 2 in 1 activating lever is in said forward position;
(c) a seat height adjustment assembly coupled to said shaft member and coupled to said seat rest; and
(d) a seat inclination adjustment assembly coupled to said shaft member and contained within said seat back.

8. The adjustable automotive seat assembly of claim 7, wherein said seat height adjustment assembly is coupled to said inner rotating shaft and wherein said seat inclination adjustment assembly is coupled to said outer rotating shaft.

9. The adjustable automotive seat assembly of claim 8 further characterized wherein said front cam and said outer rotating shaft rotate in a first direction when said 2 in 1 activating lever is in said rearward position and said upward position to allow said seat inclination assembly to move said seat back forwardly towards said seat rest or rearwardly away from said seat rest, wherein said first direction is selected from the group consisting of a clockwise direction and a counterclockwise direction.

10. The adjustable automotive seat assembly of claim 8 further characterized wherein said rear cam and said inner rotating shaft rotate in a first direction when said 2 in 1 activating lever is in said forward position and said upward position to allow said seat height adjustment mechanism to move said seat upwardly or downwardly relative to said floor, wherein said first direction is selected from the group consisting of a clockwise direction and a counterclockwise direction.

11. The adjustable automotive seat assembly of claim 8 further characterized wherein said front cam and said outer rotating shaft rotate in a first direction when said 2 in 1 activating lever is in said rearward position and said upward position; and
wherein said rear cam and said inner rotating shaft rotate in a first direction when said 2 in 1 activating lever is in said forward position and said upward position, wherein said first direction is selected from the group consisting of a clockwise direction and a counterclockwise direction.

12. The adjustable automotive seat assembly of claim 8 further comprising:
a first lever coupled to said 2 in 1 activating lever; and
a slide coupled between said 2 in 1 activating lever and said bracket.

13. The adjustable automotive seat assembly of claim 7, wherein said seat height adjustment assembly is coupled to said outer rotating shaft and wherein said seat inclination adjustment assembly is coupled to said inner rotating shaft.

14. The adjustable automotive seat assembly of claim 13 further characterized wherein said front cam and said outer rotating shaft rotate in a first direction when said 2 in 1 activating lever is in said rearward position and said upward position to allow said seat height adjustment mechanism to move said seat upwardly or downwardly relative to said floor, wherein said first direction is selected from the group consisting of a clockwise direction and a counterclockwise direction.

15. The adjustable automotive seat assembly of claim 13 further characterized wherein said rear cam and said inner rotating shaft rotate in a first direction when said 2 in 1 activating lever is in said forward position and said upward position to allow said seat inclination assembly to move said seat back forwardly towards said seat rest or rearwardly away from said seat rest, wherein said first direction is selected from the group consisting of a clockwise direction and a counterclockwise direction.

16. The adjustable automotive seat assembly of claim 13 further characterized wherein said front cam and said outer rotating shaft rotate in a first direction when said 2 in 1 activating lever is in said rearward position and said upward position; and
wherein said rear cam and said inner rotating shaft rotate in a first direction when said 2 in 1 activating lever is in said forward position and said upward position, wherein said first direction is selected from the group consisting of a clockwise direction and a counterclockwise direction.

17. The adjustable automotive seat assembly of claim 13 further comprising:
a first lever coupled to said 2 in 1 activating lever; and
a slide coupled between said 2 in 1 activating lever and said bracket.

18. A method for adjusting the seat height and seat inclination angle of an automotive seat assembly, the method comprising
providing a seat having a seat rest and a seat back and a side portion;
coupling a seat height adjustment assembly and a seat inclination adjustment assembly within said seat;
forming an adjustment assembly including a 2 in 1 activating lever and a shaft portion comprising a first rotating shaft and a second rotating shaft, said 2 in 1 activating lever movable from a first position to a second position and independently movable from a downward position to an upward position, said first position selected from the group consisting of a forward position and a rearward position and said second position selected from the group consisting of said forward position and said rearward position, said first position being different than said second position;
coupling said adjustment assembly to said side portion;
operatingly coupling said first rotating shaft to said seat height adjustment assembly and operatingly coupling said second rotating shaft to said seat inclination adjustment assembly;
actuating said seat height adjustment assembly to adjust said height of said seat by placing said 2 in 1 activating lever in said first position and independently moving said 2 in 1 activating lever from said downward position to said upward position; and
actuating said seat inclination adjustment assembly to adjust an inclination of said seat back relative to said seat rest by placing said 2 in 1 activating lever in said second position and independently moving said 2 in 1 activating lever from said downward position to said upward position

19. The method of claim 18, wherein said first rotating shaft comprises an inner rotating shaft and said second rotating shaft comprises an outer rotating shaft.

20. The method of claim 18, wherein said first rotating shaft comprises an outer rotating shaft and said second rotating shaft comprises an inner rotating shaft.
